(19) United States
(12) Patent Application Publication
(10) Pub. No.: US 2024/0273418 A1
(43) Pub. Date: Aug. 15, 2024

(54) AGGREGATING UNIQUE TRAINING DATA

(71) Applicant: Legion Technologies, Inc., Santa Clara, CA (US)

(72) Inventors: Farshad Kheiri, Manhattan Beach, CA (US); Fatemeh Jafari, Kitchener (CA); Gopalakrishnan Sundaram, Saratoga, CA (US); Hanson Allen Egbert, Avila Beach, CA (US); Sanish Mondkar, San Francisco, CA (US); Nicolas Eduardo Escobar Pinzon, Bogotá (CO); Thomas A. Joseph, Atherton, CA (US)

(21) Appl. No.: 18/436,623

(22) Filed: Feb. 8, 2024

Related U.S. Application Data
(60) Provisional application No. 63/484,362, filed on Feb. 10, 2023.

(51) Int. Cl. G06N 20/20

(52) U.S. Cl. CPC G06N 20/20

(57) ABSTRACT

Methods, systems, and computer-readable media that include processes related to training improved machine learning models using aggregated and unique training data. In one example, a process includes identifying a rare event for which a predicted target variable is to be generated, training a naïve machine learning model to generate the predicted target variable using a particular subset of the training data, and determining that a sparsity of training data exists for the rare event in the particular subset of training data. The process also includes the actions of, in response to determining that a sparsity off training data exists for the rare event in the particular subset of the training data, selecting other subsets of the training data, and identifying feature sets that are associated with the rare event from the selected other subsets of the training data.

### CROSS-REFERENCE TO RELATED APPLICATION

This application claims the benefit of U.S. Provisional Pat. App. No. 63/484,362, filed Feb. 10, 2023, which is incorporated herein by reference.

### FIELD

The present invention relates to the field of machine learning, and more specifically to solutions related to training improved machine learning models using aggregated and unique training data.

### BACKGROUND

It can be difficult to obtain the large amounts of training data that is often needed to train a reliable machine learning model. When ‘real world’ training data is not available in the right amounts, legacy techniques such as training data augmentation or synthetic data generation can be used to obtain additional training data, however these existing techniques are not without their drawbacks. For instance, some legacy techniques generate additional training data at random. Using these techniques, there is no assurance that this randomly generated data will be applicable to situations of interest in the real world, and thus machine learning models that are trained to produce accurate, real world predictions based on this randomly generated data might still be unreliable.

### SUMMARY

This specification discloses enhanced techniques for aggregating unique training data for use in training improved machine learning models.

According to one example implementation, in a multi-dataset environment where separate models are built for each dataset (or “subset” of the multi-dataset), unique feature sets are identified and extracted for rare events from some of the subsets for use in training a special machine learning model to generate ‘intermediate’ predicted target variables. This model can discern interactions or relationships between these unique feature sets and the predicted target variables. The intermediate results of this special machine learning model can be ensembled with intermediate results generated by a machine learning model (or models) that is not trained on unique feature sets for the rare events (“naïve” machine learning model or models), to improve the accuracy or reliability of an ensembled, or ‘final’ predicted target variable.

In some examples, the unique feature sets may relate to rare events that have been observed in some of the data subsets but not others of the data subsets, such as rare weather events that have not occurred at one location of a retail outlets, or new or unusual cyberattacks that have not occurred at a particular portion of an enterprise computing network. In these examples, the predicted target variable might be a demand forecast, or a real-time indication that a cyberattack is underway.

A rare event may be an event that is not reflected in some subsets of a dataset at all, but that may occur in the future. If a dataset includes twenty feature sets that pertain to a six-inch snow event but one subset of the dataset does not include any feature sets that pertain to a six-inch snow event, e.g., because the subset originated during the summer, the six-inch snow event is considered a rare event. In other examples, an event might still be considered a rare event if it occurs in the subset fewer than a threshold quantity of times.

A rare event defined as an event that might not exist in some datasets at all, but it occurs in future. For ex. If 6 inches snow exists 20 times in a dataset and if it does not exist in one dataset at the moment (has data just over Summer.), the 6-inch snow is considered a rare event.

According to one general implementation, a process includes training a naïve machine learning model to generate a predicted target variable for a rare event using a particular subset of the training data, and determining that a sparsity of training data exists for the rare event in the particular subset of training data. The process also includes the actions of, in response to determining that a sparsity off training data exists for the rare event in the particular subset of the training data, selecting other subsets of the training data, identifying feature sets that are associated with the rare event from the selected other subsets of the training data, generating a special training data set that includes the feature sets that are associated with the rare events from the selected other subsets of the training data, training a special machine learning model to generate the predicted target variable using the special training data set, and obtaining, as intermediate predicted target variables, the predicted target variable from each of the special machine learning model and the naïve machine learning model. Further, the process includes determining an ensembled predicted target variable based on the intermediate predicted target variables, and providing the ensembled predicted target variable for output.

In some implementations, identifying the rare event may include receiving a user selection of a rare event type. Identifying the rare event may include determining that a target variable cannot be predicted for a rare event with a threshold level of confidence. Identifying the rare event may include determining that a quantity of feature sets in the particular subset of training data fails to satisfy a threshold. Selecting the other subsets may include determining that the other subsets share a common characteristic with the particular subset. Selecting the other subsets may include determining that the other subsets are associated with physical locations that are within a predetermined distance of a physical location that is associated with the particular subset. The special machine learning model may be a gradient boosted tree (GBT). Determining the ensembled predicted target variable may include selecting one of the intermediate predicated target variables that has a maximum value.

These processes may be embodied in methods, systems that include processors and computer-readable storage media, and in non-transitory computer-readable storage media itself.

Particular embodiments of the subject matter described in this specification can be implemented so as to realize one or more of the following advantages. In some implementations, the predicted target variables may be more accurate than those which have not been generated by or ensembled with those of a special machine learning model. The generation of synthesized or random training data can be avoided, saving expensive computational resources. Fewer machine learning models need to be trained, and those that are trained can be trained using less training data, also reducing the expenditure of computational resources. Because the predicted target variables are more accurate than those of legacy approaches, downstream computer processing pipelines can operate with a higher confidence that the predicted target variables are accurate, and expend fewer resources filtering, augmenting, further ensembling, recomputing, double-checking or otherwise re-processing these variables.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates one aspect of an enhanced model training process.

FIG. 2 illustrates another aspect of an enhanced model training process.

FIG. 3 illustrates an additional aspect of an enhanced model training process.

FIG. 4 is a flowchart of an enhanced process for aggregating unique training data.

### DETAILED DESCRIPTION

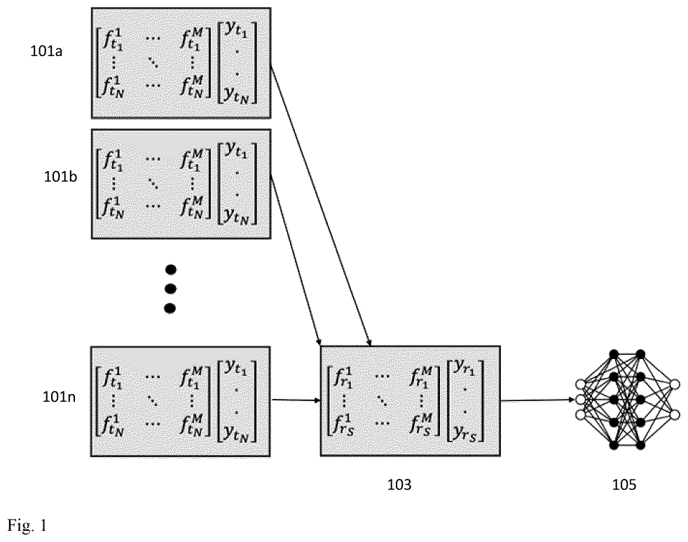

FIG. 1 illustrates one aspect of an enhanced model training process. Generally speaking the enhanced model training process allows for the aggregation of unique training data which can be used to train machine learning models to produce accurate results.

In some examples, this enhanced model training process occurs in a multi-dataset environment where separate models are built for each data subset (e.g., data sets 101a to 101n). Unique feature sets from some of the data subsets are identified and extracted for use in training a special machine learning model to generate intermediate predicted target variables. This model can discern interactions or relationships between these unique feature sets and the predicted target variables. The intermediate results of this special machine learning model can be ensembled with intermediate results generated by a naïve machine learning model (or models) that is not trained on unique feature sets, to improve the accuracy or reliability of an ensembled, or final predicted target variable.

In some examples, the unique feature sets may relate to rare events that have been observed in some of the data subsets but not others of the data subsets, such as rare weather events that have not occurred at one location of a retail outlets, or new or unusual cyberattacks that have not occurred at a particular portion of an enterprise computing network. In these examples, the predicted target variable might be a demand forecast, or a real-time indication that a cyberattack is underway.

A rare event may be an event that is not reflected in some subsets of a dataset at all, but that may occur in the future. If a dataset includes twenty feature sets that pertain to a political protest event but one subset of the dataset does not include any feature sets that pertain to political protests, e.g., because the subset originated outside of an election year, the political protest event is considered a rare event.

For context, machine learning models (e.g., machine learning model 105) use multi-dataset training data that includes features sets, to learn patterns of the features and to quantify the impact of each feature or set of features on a target variable. If a feature set that a machine learning model has not been trained on is input to the machine learning model, the machine learning model may generate inaccurate predictions for the target variable, or might waste computational resources training or updating models to attain a higher level of accuracy. Without performing the enhanced machine learning model training process described by this specification, a machine learning model might generate inaccurate predictive target variables when, for example a feature set is unique or rare, and when the machine learning model has not been trained on the same or similar unique or rare training data.

In some situations, training data is not monolithic, and can be allocated into different or overlapping subsets of training data. These subsets may be allocated based on similarity, or based on a shared characteristic. In some examples, training data for a financial model, for instance, might divide training data that was generated at different bank branches into different subsets. Training data for a click rate model might divide training data that was generated on different web pages or for different categories of products into different subsets. Training data for a customer loyalty model might divide training data that was generated at different brick-and-mortar store locations into different subsets. In these examples, the subset includes feature sets and target variables (or “labels”) for each feature set.

When training a machine learning model using a subset of training data, one can encounter the situation where there is an insufficient quantity of feature sets (or “samples”) to train a model to reproduce a predicted target variable that is included in the training data, or to produce accurate predictions of target variables based on the training data. If, to address this sparsity, training data from different subsets are used to augment the training data of a particular subset, the predicted target variables made by the model might be incorrect because of dissimilarities or differences in characteristics across the disparate subsets. However, such predicted target variables can be adjusted, or ensembled with other predicted target variables, to improve accuracy.

Take, for example, a machine learning model that is used for identifying and mitigating various types of cyberattacks and security risks. These risks can include unauthorized access, malware, denial-of-service attacks, phishing, zero-day attacks, and others. Each type of attack has its own characteristics that can be reflected in feature sets, and machine learning models can be trained to detect patterns and anomalies within feature sets that may suggest that a cyberattack attack is occurring.

For each type of attack, a specific machine learning model can be trained using training data for that type of attack, e.g., historical data from occurrences of previous attacks of that type, as well as from times previous attacks of that type were not occurring. Additionally, for security or other reasons, separate machine learning models might be trained for each type of attack, e.g., for each part of an enterprise computer network or for each of different departments.

Over time, cyberattacks of one type may occur frequently, but cyberattacks of another type may occur infrequently. Similarly, cyberattacks may often affect one part of an enterprise computer network, but other parts of the enterprise computer network may not experience cyberattacks. As these examples show, the amount of historical data that may be available for use as training data for each subset may be vastly different, and in some situations a particular subset may have little or no historical data available at all.

In another example, a machine learning model may be trained for use in workforce management, where predictions are driven by trends, seasonality and the occurrence of events. If an event that is not captured in the training data, such as an extreme weather event, occurs, the machine learning model may produce inaccurate predictions because it was not exposed to training data that reflects how similar events effected a target variable in the past.

In any situation that the enhanced techniques described by this specification are used, the predicted target variables that are output by machine learning models can be rectified or ensembled with outputs of other models to produce more accurate results.

In more detail, the enhanced techniques include a process for training a machine learning model 105 to generate accurate predictions when insufficient training data is available in a subset of training data, e.g., for a rare event.

To begin, a sparsity of training data is identified in a subset of training data 101n. In some examples, this sparsity is recognized when it is determined that feature sets associated with a particular rare event or event type exist in a particular subset of the training data. A rare event can be, for example, a type of cyberattack that has never occurred before on a particular portion of an enterprise computer network, an extreme weather event, or a new type of promotion that has not been tried before, or any other type of event whose effect might be reflected in training data.

In other examples, a sparsity of the training data may not be associated with an event per se, but rather with a determination that predicted target variables that are output by a machine learning model have low confidence values. In other examples, a rare event might be a confluence of circumstances that are not easily perceivable by a human, but rather it might be a pattern of facts that are only discernable to a machine via an evaluation of complex feature sets.

In some examples, the sparsity of training data can be automatically recognized, e.g., by determining that a confidence value associated with predicted target variables generated by a machine learning mode that is trained on the training data is below a threshold amount, or by determining that a number of feature sets that includes information relating to a rare event does not satisfy a threshold amount. In other examples, a sparsity of training data can be automatically recognized and indicated, e.g., by a user indicating via a form or user interface control that a certain rare event or rare event has never occurred or has only infrequently occurred in connection at a physical location that is associated with the particular subset of the training data.

Other or different subsets (e.g., subsets 101a and 101b) of training data are obtained to augment the particular subset. The different subsets of the training data may be those subsets that are identified as including training data that is similar to the particular subset, such as training data that shares one or more characteristics with the particular subset. For example, training data may be obtained for different parts of a same enterprise computer network, or for nearby stores, or for similar promotions.

The process of identifying and obtaining different subsets of training data can be repeated if the obtained training data is evaluated and determined to still be insufficient to train a machine learning model to generate accurate predictions associated with the rare event. In some examples, different subsets of training data are obtained until a predetermined number, e.g., 100, 1,000, 100,000, of feature sets are aggregated for a particular rare event.

Feature sets (if any) that are specific to the rare event are selected from each of the different subsets of training data that are obtained to augment the particular subset. For example, a feature set that is associated with an effect of an extreme weather event on a nearby store, or an occurrence of a cyberattack on a different part of an enterprise computer network, may be identified from a subset of training data associated with the nearby store or the different part, respectively. If the particular subset itself includes any, e.g., a small number of, feature sets that are associated with the rare event, that data may be selected for use in augmentation.

From each of the different subsets, the rows that represent the rare events are sampled. If there are several samples of the same rare event, certain rows, e.g., the most recent rows, are selected. A new dataset of these sampled rows is formed for the rare event from the different subsets.

A new training data set 103 is generated using some or all of the selected feature sets. In some examples, this new training data set includes only feature sets that are specific to the rare event. In other examples, the training data set includes other feature sets, such as those from the original, particular subset, and/or other feature sets from the obtaining different subsets. The selected feature sets are put together or aggregated to create a new dataset.

In one example, a business with many physical outlets have thousands or even millions of records pertaining to transactions that have occurred at the physical outlets. Each record might include data such as location information, time and date information, price information, item description information, payment information, and/or many other fields pertaining to the transaction. To generate a model that predicts the demand for certain products that are sold at different locations, the business might train machine learning models that are specific to each physical outlet, where the machine learning model for a particular physical outlet is trained using only those records that were generated for the physical outlet as training data.

Using these records to train a model for each physical outlets, a model for a physical outlet in a northern location might not be generate an accurate forecast of demand for certain products if unusually warm weather is expected in the near future. To address this situation, the business might identify records from other physical outlets that have experienced similar temperatures or temperature deviations have occurred. The records for those other physical locations can be identified and selected, and aggregated together to generate a new training data set that includes those records, or features from those records. The new training data set might include only those records (as feature sets) where the rare event has occurred, or might include a majority of records where the rare event has occurred, or some other combination of records.

In some examples, the new training data set is unique in a sense that it contains just the rare feature sets that are insufficiently represented in the particular subset. Since these feature sets are sampled from other different subsets, perhaps many other different subsets, there could be high variation among the feature sets. Training an enhanced machine learning model 105 that is capable of discerning the interactions and relationships between the feature sets and the predicted target variables can be useful in making a final predicted target variable accurate.

The new training data is informative in a machine learning training process because it includes uncommon information bits. These bits can be selected from a wide variety of training data subsets, reflecting many differences. If a prediction tool can be trained to indicate how these different information bits relate to a particular predicted target variable, this prediction tool will be better at making predictions in situations where these uncommon information bits are not present.

The new training data is used to train an enhanced machine learning model, e.g., a non-linear based model, which captures the interactions between the features in several layers, to forecast the target variable in context with the rare event. To differentiate it from any other machine learning model referenced by this specification, this enhanced machine learning model may be referred to as a “special machine learning model,” or just a “special model.” Such a model may be a non-linear model that maps values of different features, e.g., such as trending, range of demand volumes, temporal features which reflect the time of the event, and target variables. Temporal features may be used to correlate a time of the event to an impact of an event.

Demand volume and trending features in the time periods prior to the rare event help the special machine learning model to determine the same size store intuitively. For example, looking in sales transaction records for at recent weeks, if the sales at a physical outlet of a business is at level between $10,000 to $20,000 and the growth rate for the physical outlet is 0.1%, and a different physical outlet has sales at a level between $100,000 to $200,000 and a growth rate of 0.001%, the enhanced process described by this specification may use these values choose whether training data subsets for one physical outlet should be used to generate new training data for the other physical outlet an insufficiency in training data is recognized.

The type of the special machine learning model and tuning parameters can be chosen to improve the accuracy of predicted target variables. In one example, gradient boosting trees (GBTs) are used, and tuning parameters include learning rate, maximum depth, minimum child rate and number of estimators. In some situations, GBTs perform better than artificial neural networks (ANN), since there are fewer levels of interactions between input features, as well as the fact that ANNs tend to overfit when less training data is available. In other situations, such as when more training data is available, may ANNs outperform gradient boosting models.

The trained, special machine learning model is used to generate predictions of a target variable for the selected, rare event.

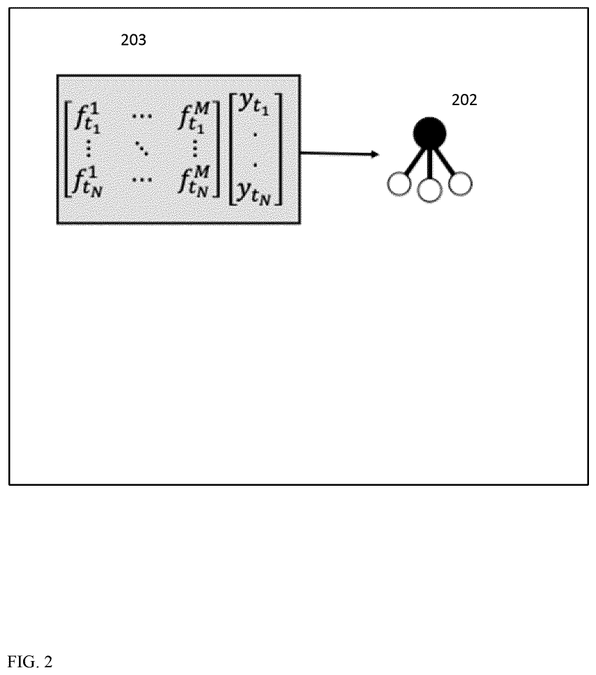

FIG. 2 illustrates another aspect of an enhanced model training process. As shown in FIG. 2, a naïve machine learning model 202 is trained using the particular subset 203 of the training data. In some examples, the naïve machine learning model is trained using the particular subset of the training data alone, with no other training data from any other subset. The naïve machine learning model is referred to as naïve because, for example, it is trained using a training data subset that it has insufficient training data for a particular rare event.

The particular subset that is used to train the naïve machine learning model may generate naïve intermediate target variable predictions (“naïve forecasts,” or “intermediate predicted target variables”), since the naïve machine learning model was trained using limited training data which included an insufficient amount of feature sets associated with the rare event.

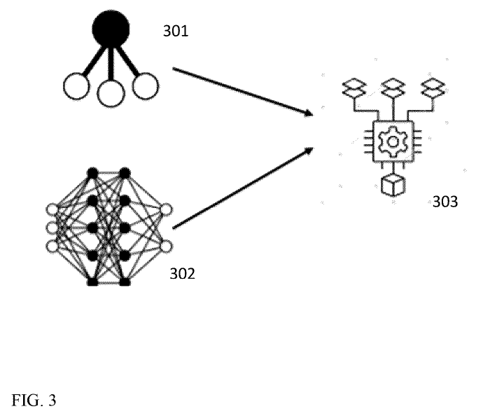

FIG. 3 illustrates an additional aspect of an enhanced model training process. Special intermediate target variable predictions (“special forecasts,” or also “intermediate predicted target variables”) are generated using the enhanced machine learning model that is trained on the new training data, and ensembled predicted target variables 303 are generated based on the intermediate predicted target variables generated by the enhanced machine learning model 302 and the naïve machine learning model 301.

In some implementations, a forecast that has a maximum value, from among the predicted target variables of the enhanced machine learning model and the naïve machine learning model, is selected as the ensemble forecast. In other implementations, the minimum value, or average value, or a weighted value is selected.

To its advantage, the enhanced training process described by this specification is configure to output predicted target variables that may be more accurate than those which have not been generated by or ensembled with those of a special machine learning model. The generation of synthesized or random training data can be avoided, saving expensive computational resources. Fewer machine learning models need to be trained, and those that are trained can be trained using less training data, also reducing the expenditure of computational resources. Because the predicted target variables are more accurate than those of legacy approaches, downstream computer processing pipelines can operate with a higher confidence that the predicted target variables are accurate, and expend fewer resources filtering, augmenting, further ensembling, recomputing, double-checking or otherwise re-processing these variables.

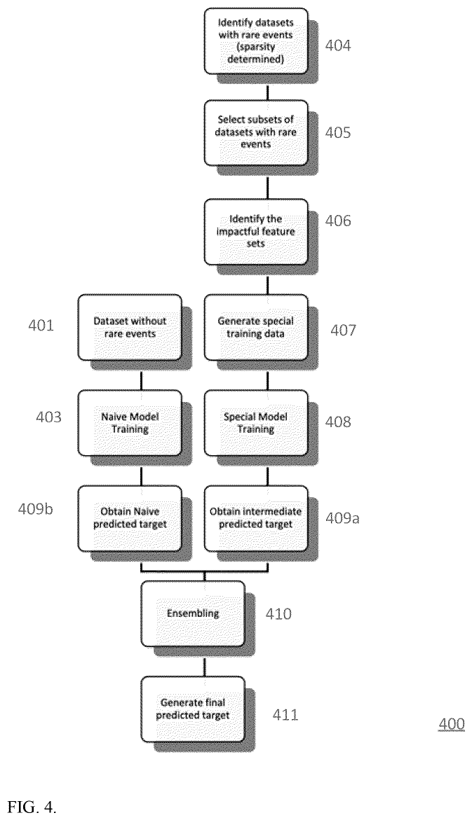

FIG. 4 is a flowchart of an enhanced process 400 for aggregating unique training data. Briefly the process 400 includes the actions of identifying a rare event for which a predicted target variable is to be generated, training a naïve machine learning model to generate the predicted target variable using a particular subset of the training data, and determining that a sparsity of training data exists for the rare event in the particular subset of training data. The process 400 also includes the actions of, in response to determining that a sparsity off training data exists for the rare event in the particular subset of the training data, selecting other subsets of the training data, identifying feature sets that are associated with the rare event from the selected other subsets of the training data, generating a special training data set that includes the feature sets that are associated with the rare events from the selected other subsets of the training data, training a special machine learning model to generate the predicted target variable using the special training data set, and obtaining, as intermediate predicted target variables, the predicted target variable from each of the special machine learning model and the naïve machine learning model. Further, the process 400 includes determining an ensembled predicted target variable based on the intermediate predicted target variables, and providing the ensembled predicted target variable for output.

In more detail, process 400 begins (401), and a naïve machine learning model is trained to generate the predicted target variable using a particular subset of the training data (403).

It is determined that a sparsity of training data exists for the rare event in the particular subset of training data (404). The sparsity may be determined via manual selection, e.g., when a user selects an event or event type from a user interface, or automatic identification, e.g., when a computer determines that a target variable cannot be predicted with a threshold confidence or when an insufficient quantity of feature sets, i.e., less than one, or less than ten, or less than 1-in-100, are identified in a subset of training data.

In response to determining that a sparsity off training data exists for the rare event in the particular subset of the training data, other subsets of the training data are selected (405). The other subsets may be subsets that have similar characteristics as the particular subset. For instance, the other subsets may be datasets that are associated with nearby stores, similar past promotions, or different portions of a same enterprise computer network.

Feature sets that are associated with the rare event from the selected other subsets of the training data are identified (406). For example, a feature set that is associated with an effect of an extreme weather event on a nearby store, or an occurrence of a cyberattack on a different part of an enterprise computer network, may be identified from a subset of training data associated with the nearby store or the different part, respectively.

A special training data set is generated that includes the feature sets that are associated with the rare events from the selected other subsets of the training data (407). The selected feature sets are put together or aggregated to create a new dataset. A special machine learning model, e.g., a GBT, is trained to generate the predicted target variable using the special training data set (408).

The predicted target variable from each of the special machine learning model and the naïve machine learning model are obtained, as intermediate predicted target variables (409a, 409b), and an ensembled predicted target variable is determined based on the intermediate predicted target variables (410). In some implementations, the larger of the intermediate predicted target variables are selected.

The ensembled predicted target variable is provided for output (411), thereby ending the process 400.

Using the process illustrated in FIG. 4, the predicted target variables may be more accurate than those which have not been generated by or ensembled with those of a special machine learning model. The generation of synthesized or random training data can be avoided, saving expensive computational resources. Fewer machine learning models need to be trained, and those that are trained can be trained using less training data, also reducing the expenditure of computational resources. Because the predicted target variables are more accurate than those of legacy approaches, downstream computer processing pipelines can operate with a higher confidence that the predicted target variables are accurate, and expend fewer resources filtering, augmenting, further ensembling, recomputing, double-checking or otherwise re-processing these variables.

The subject matter and the actions and operations described in this specification can be implemented in digital electronic circuitry, in tangibly-embodied computer software or firmware, in computer hardware, including the structures disclosed in this specification and their structural equivalents, or in combinations of one or more of them. The subject matter and the actions and operations described in this specification can be implemented as or in one or more computer programs, e.g., one or more modules of computer program instructions, encoded on a computer program carrier, for execution by, or to control the operation of, data processing apparatus. The carrier can be a tangible non-transitory computer storage medium. Alternatively or in addition, the carrier can be an artificially-generated propagated signal, e.g., a machine-generated electrical, optical, or electromagnetic signal, that is generated to encode information for transmission to suitable receiver apparatus for execution by a data processing apparatus. The computer storage medium can be or be part of a machine-readable storage device, a machine-readable storage substrate, a random or serial access memory device, or a combination of one or more of them. A computer storage medium is not a propagated signal.

The term “data processing apparatus” encompasses all kinds of apparatus, devices, and machines for processing data, including by way of example a programmable processor, a computer, or multiple processors or computers. Data processing apparatus can include special-purpose logic circuitry, e.g., an FPGA (field programmable gate array), an ASIC (application-specific integrated circuit), or a GPU (graphics processing unit). The apparatus can also include, in addition to hardware, code that creates an execution environment for computer programs, e.g., code that constitutes processor firmware, a protocol stack, a database management system, an operating system, or a combination of one or more of them.

A computer program can be written in any form of programming language, including compiled or interpreted languages, or declarative or procedural languages; and it can be deployed in any form, including as a stand-alone program, e.g., as an app, or as a software module, component, engine, subroutine, or other unit suitable for executing in a computing environment, which environment may include one or more computers interconnected by a data communication network in one or more locations.

A computer program may, but need not, correspond to a file in a file system. A computer program can be stored in a portion of a file that holds other programs or data, e.g., one or more scripts stored in a markup language document, in a single file dedicated to the program in question, or in multiple coordinated files, e.g., files that store one or more modules, sub-programs, or portions of code.

The processes and logic flows described in this specification can be performed by one or more computers executing one or more computer programs to perform operations by operating on input data and generating output. The processes and logic flows can also be performed by special-purpose logic circuitry, e.g., an FPGA, an ASIC, or a GPU, or by a combination of special-purpose logic circuitry and one or more programmed computers.

Computers suitable for the execution of a computer program can be based on general or special-purpose microprocessors or microcontrollers or a combination of them, or any other kind of central processing unit. Generally, a central processing unit will receive instructions and data from a read-only memory or a random access memory or both. The essential elements of a computer are a central processing unit for executing instructions and one or more memory devices for storing instructions and data. The central processing unit and the memory can be supplemented by, or incorporated in, special-purpose logic circuitry.

Generally, a computer will also include, or be operatively coupled to, one or more mass storage devices, and be configured to receive data from or transfer data to the mass storage devices. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

To provide for interaction with a user, the subject matter described in this specification can be implemented on one or more computers having, or configured to communicate with, a display device, e.g., a LCD (liquid crystal display) monitor, or a virtual-reality (VR) or augmented-reality (AR) display, for displaying information to the user, and an input device by which the user can provide input to the computer, e.g., a keyboard and a pointing device, e.g., a mouse, a trackball or touchpad. Other kinds of devices can be used to provide for interaction with a user as well; for example, feedback and responses provided to the user can be any form of sensory feedback, e.g., visual, auditory, speech, or tactile feedback or responses; and input from the user can be received in any form, including acoustic, speech, tactile, or eye tracking input, including touch motion or gestures, or kinetic motion or gestures or orientation motion or gestures. In addition, a computer can interact with a user by sending documents to and receiving documents from a device that is used by the user; for example, by sending web pages to a web browser on a user's device in response to requests received from the web browser, or by interacting with an app running on a user device, e.g., on a smartphone or electronic tablet. Also, a computer can interact with a user by sending text messages or other forms of message to a personal device, e.g., a smartphone that is running a messaging application, and receiving responsive messages from the user in return.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform the operations or actions. That one or more computer programs is configured to perform particular operations or actions means that the one or more programs include instructions that, when executed by data processing apparatus, cause the apparatus to perform the operations or actions. That special-purpose logic circuitry is configured to perform particular operations or actions means that the circuitry has electronic logic that performs the operations or actions.

The subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of what is being claimed, which is defined by the claims themselves, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially be claimed as such, one or more features from a claimed combination can in some cases be excised from the combination, and the claim may be directed to a subcombination or variation of a subcombination.

Similarly, while operations are depicted in the drawings and recited in the claims in a particular order, this by itself should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method comprising:
training a naïve machine learning model to generate a predicted target variable for a rare event using a particular subset of the training data;
determining that a sparsity of training data exists for the rare event in the particular subset of the training data;
in response to determining that a sparsity off training data exists for the rare event in the particular subset of the training data, selecting other subsets of the training data;
identifying feature sets that are associated with the rare event from the selected other subsets of the training data;
generating a special training data set that includes the feature sets that are associated with the rare events from the selected other subsets of the training data;
training a special machine learning model to generate the predicted target variable using the special training data set;
obtaining, as intermediate predicted target variables, the predicted target variable from each of the special machine learning model and the naïve machine learning model;
determining an ensembled predicted target variable based on the intermediate predicted target variables; and
providing the ensembled predicted target variable for output.

2. The method of claim 1, wherein identifying the rare event comprises receiving a user selection of a rare event type.

3. The method of claim 1, wherein identifying the rare event comprises determining that a target variable cannot be predicted for a rare event with a threshold level of confidence.

4. The method of claim 1, wherein identifying the rare event comprises determining that a quantity of feature sets in the particular subset of training data fails to satisfy a threshold.

5. The method of claim 1, wherein selecting the other subsets comprises determining that the other subsets share a common characteristic with the particular subset.

6. The method of claim 1, wherein selecting the other subsets comprises determining that the other subsets are associated with physical locations that are within a predetermined distance of a physical location that is associated with the particular subset.

7. The method of claim 1, wherein the special machine learning model comprises a gradient boosted tree (GBT).

8. The method of claim 1, wherein determining the ensembled predicted target variable comprises selecting one of the intermediate predicated target variables that has a maximum value.

9. A system comprising:
one or more processors, and
one or more computer-readable storage media that includes instructions which, when executed by the one or more processors, cause the one or more processors to perform operations comprising:
training a naïve machine learning model to generate a predicted target variable for a rare event using a particular subset of the training data;
determining that a sparsity of training data exists for the rare event in the particular subset of the training data;
in response to determining that a sparsity off training data exists for the rare event in the particular subset of the training data, selecting other subsets of the training data;
identifying feature sets that are associated with the rare event from the selected other subsets of the training data;
generating a special training data set that includes the feature sets that are associated with the rare events from the selected other subsets of the training data;
training a special machine learning model to generate the predicted target variable using the special training data set;
obtaining, as intermediate predicted target variables, the predicted target variable from each of the special machine learning model and the naïve machine learning model;
determining an ensembled predicted target variable based on the intermediate predicted target variables; and
providing the ensembled predicted target variable for output.

10. The system of claim 9, wherein identifying the rare event comprises receiving a user selection of a rare event type.

11. The system of claim 9, wherein identifying the rare event comprises determining that a target variable cannot be predicted for a rare event with a threshold level of confidence.

12. The system of claim 9, wherein identifying the rare event comprises determining that a quantity of feature sets in the particular subset of training data fails to satisfy a threshold.

13. The system of claim 9, wherein selecting the other subsets comprises determining that the other subsets share a common characteristic with the particular subset.

14. The system of claim 9, wherein selecting the other subsets comprises determining that the other subsets are associated with physical locations that are within a predetermined distance of a physical location that is associated with the particular subset.

15. The system of claim 9, wherein the special machine learning model comprises a gradient boosted tree (GBT).

16. The system of claim 9, wherein determining the ensembled predicted target variable comprises selecting one of the intermediate predicated target variables that has a maximum value.

17. A computer-readable storage medium that includes instructions which, when executed by one or more processors, cause the one or more processors to perform operations comprising:
training a naïve machine learning model to generate a predicted target variable for a rare event using a particular subset of the training data;
determining that a sparsity of training data exists for the rare event in the particular subset of the training data;
in response to determining that a sparsity off training data exists for the rare event in the particular subset of the training data, selecting other subsets of the training data;
identifying feature sets that are associated with the rare event from the selected other subsets of the training data;
generating a special training data set that includes the feature sets that are associated with the rare events from the selected other subsets of the training data;
training a special machine learning model to generate the predicted target variable using the special training data set;
obtaining, as intermediate predicted target variables, the predicted target variable from each of the special machine learning model and the naïve machine learning model;
determining an ensembled predicted target variable based on the intermediate predicted target variables; and
providing the ensembled predicted target variable for output.

18. The medium of claim 17, wherein identifying the rare event comprises receiving a user selection of a rare event type.

19. The medium of claim 17, wherein identifying the rare event comprises determining that a target variable cannot be predicted for a rare event with a threshold level of confidence.

20. The medium of claim 17, wherein identifying the rare event comprises determining that a quantity of feature sets in the particular subset of training data fails to satisfy a threshold.
